(19) United States
(12) Patent Application Publication
(10) Pub. No.: US 2013/0086222 A1
(43) Pub. Date: Apr. 4, 2013

(54) CONTENT PROCESSING SYSTEM, SERVER DEVICE, AND CONTENT REPRODUCING DEVICE

(71) Applicants: Hiroshi Kazawa, Saitama (JP); Hideo Kataoka, Tokyo (JP)

(72) Inventors: Hiroshi Kazawa, Saitama (JP); Hideo Kataoka, Tokyo (JP)

(21) Appl. No.: 13/529,947

(22) Filed: Jun. 21, 2012

(30) Foreign Application Priority Data
Sep. 29, 2011 (JP) 2011-215433

(51) Int. Cl. G06F 15/16

(52) U.S. Cl. 709/219

(57) ABSTRACT

According to one embodiment, a content processing system includes: a server device configured to distribute content data via a network; and a content reproducing device configured to reproduce content based on the content data distributed via the network. The server device comprises an acquisition destination allocating module to allocate one acquisition destination of the content data to be distributed to one content reproducing device; and a distribution data switching module to switch the content data to be distributed based on a switching command received. The content reproducing device comprises a content acquisition module to request the content data from the allocated acquisition destination of the content data to acquire the content data; and a switching command transmitter to generate the switching command in switching the content data to be acquired from the acquisition destination of the content data to transmit the switching command to the server device.

### CROSS-REFERENCE TO RELATED APPLICATIONS

This application is based upon and claims the benefit of priority from Japanese Patent Application No. 2011-215433, filed Sep. 29, 2011, the entire contents of which are incorporated herein by reference.

### FIELD

Embodiments described herein relate generally to a content processing system, a server device, and a content reproducing device.

### BACKGROUND

Recently, electronic devices compliant with UpnP (Universal Plug and Play) (registered trademark) AV standards and DLNA (Digital Living Network Alliance) guidelines have been used.

Here, the UPnP AV standards are defined as an upper layer of a UPnP protocol capable of allowing participation in a network by simply connecting electronic devices, and intended to reproduce AV contents.

The DLNA guidelines are industry standards realizing the compatibility among electronic devices to constitute a domestic network of the electronic devices, and adopt the UPnP protocol as procedures for the communication among the electronic devices.

In the UPnP standards, devices and a control point for controlling each device are defined. In the UPnP AV standards, as the devices, a media server (UPnP AV Media Server) for accumulating contents and a media renderer (UPnP AV Media Renderer) for reproducing the contents are defined. The control point (UPnP AV Control Point) detects and controls a device on the network. Furthermore, in the UPnP AV standards, the media renderer selected by the control point obtains and reproduces the contents stored in the media server selected by the control point via the network.

In the same manner as described above, a mechanism such that various contents are distributed and reproduced via a network in accordance with the DLNA guidelines has been developed. For example, Japanese Patent Application Laid-open No. 2008-040893 discloses a system that distributes on-air broadcast programs as contents by using a digital media server (DMS) through a network and reproduces the contents by using a digital media player (DMP) or reproduces the contents by using a digital media renderer (DMR) and a digital media controller (DMC) in combination.

However, in the conventional technique, the digital media server adopts the constitution such that an item is allocated to each content to be viewed and hence, an amount of items implemented for realizing the content distribution of all channels is increased.

Furthermore, in the digital media player, when the content to be viewed is switched, it is necessary to interrupt reproduction once, search the channel to be viewed through the container tree of CDS (Content Directory Service), and execute the GET method of HTTP for a new item corresponding to the channel to be viewed. Therefore, operations become cumbersome for a user, and it takes time to change the channels.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block schematic diagram of a content processing system according to embodiments;

FIG. 2 is an exemplary functional block diagram of the content processing system in the embodiments;

FIG. 3 is an exemplary block diagram illustrating a hardware configuration of a recorder;

FIG. 4 is an exemplary block diagram illustrating a hardware configuration of a tablet terminal device;

FIG. 5 is an exemplary schematic explanatory view of a first embodiment;

FIG. 6 is an exemplary processing timing chart of the content processing system in the embodiment;

FIG. 7 is an exemplary explanatory view of one example of HTTP GET command; and

FIG. 8 is an exemplary schematic explanatory view of a second embodiment.

### DETAILED DESCRIPTION

In general, according to one embodiment, a content processing system comprises: a server device configured to distribute content data via a network; and a content reproducing device configured to reproduce content based on the content data distributed via the network, the server device comprising: an acquisition destination allocating module configured to allocate one acquisition destination of the content data to be distributed to one content reproducing device; and a distribution data switching module configured to switch the content data to be distributed based on a switching command received, the content reproducing device comprising: a content acquisition module configured to request the content data from the allocated acquisition destination of the content data to acquire the content data; and a switching command transmitter configured to generate the switching command in switching the content data to be acquired from the acquisition destination of the content data to transmit the switching command to the server device.

Next, in conjunction with drawings, a content processing system in embodiments is explained in detail.

In the embodiments described below, although examples using devices compliant with DLNA guidelines are explained, the embodiment is not limited to these devices. For example, a characteristic constitution in embodiments described later may be applied to a device or a system compliant with the DLNA guidelines and standards equivalent to or compatible with various standards to which the DLNA guidelines conform or the like, and a device or a system having unique specifications.

### [1] First Embodiment

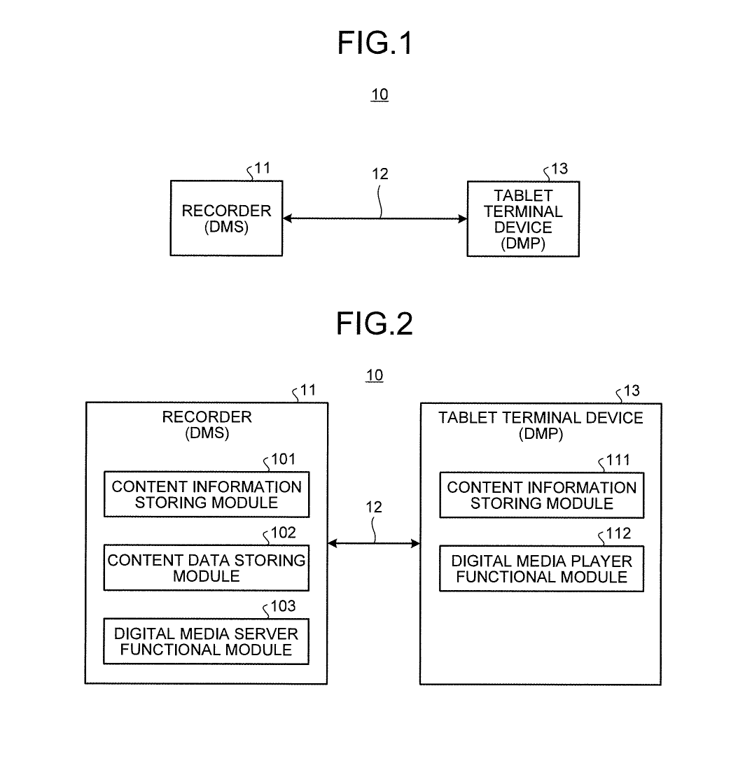

FIG. 1 is a block schematic diagram of a content processing system in the embodiments.

In FIG. 1, the content processing system is constituted of electronic devices compliant with the DLNA guidelines.

A content processing system 10 comprises, roughly, a recorder 11 and a tablet-type terminal device (hereinafter, referred to as “tablet terminal device”) 13 connected to the recorder 11 via a communication network 12 such as a LAN (Local Area Network).

The recorder 11 functions as a digital media server (DMS) specified in the DLNA guidelines, that is, a content server device. Furthermore, the recorder 11 is capable of reproducing and recording the contents by using a disk-like recording medium such as a DVD or a Blu-ray (registered trademark) disk. Here, the digital media server has functions of accumulating the contents, providing title information or the like of the contents to the other electronic devices, and supplying designated content data upon request from a digital media player (DMP) or the other electronic devices such as a digital media renderer (DMR) controlled by a digital media controller (DMC).

The communication network 12 can be constituted as a wired network, a wireless network, or a mixed network constituted by combining these networks. Furthermore, the communication network 12 can be constituted not only as a single network but also as a plurality of networks such as the LAN and the Internet.

The tablet terminal device 13 functions as the digital media player specified in the DLNA guidelines. Here, the digital media player has functions of requesting the delivery of content data from the digital media server and reproducing the content data supplied from the digital media server.

FIG. 2 is a functional block diagram of the content processing system in the embodiments.

The recorder 11 comprises a content information storage module 101, a content data storage module 102, and a digital media server functional module 103. Due to such a constitution, the recorder 11 is capable of providing the content data stored in the content data storage module 102 or the content information stored in the content information storage module 101 to the other electronic devices (tablet terminal device 13, for example) with the use of the digital media server functional module 103.

On the other hand, the tablet terminal device 13 comprises a content information storage module 111 and a digital media player functional module 112. Due to such a constitution, the tablet terminal device 13 is capable of displaying and reproducing the contents provided from the other electronic devices (recorder 11, for example) with the use of the digital media player functional module 112.

Next, the specific constitution of the recorder 11 is explained.

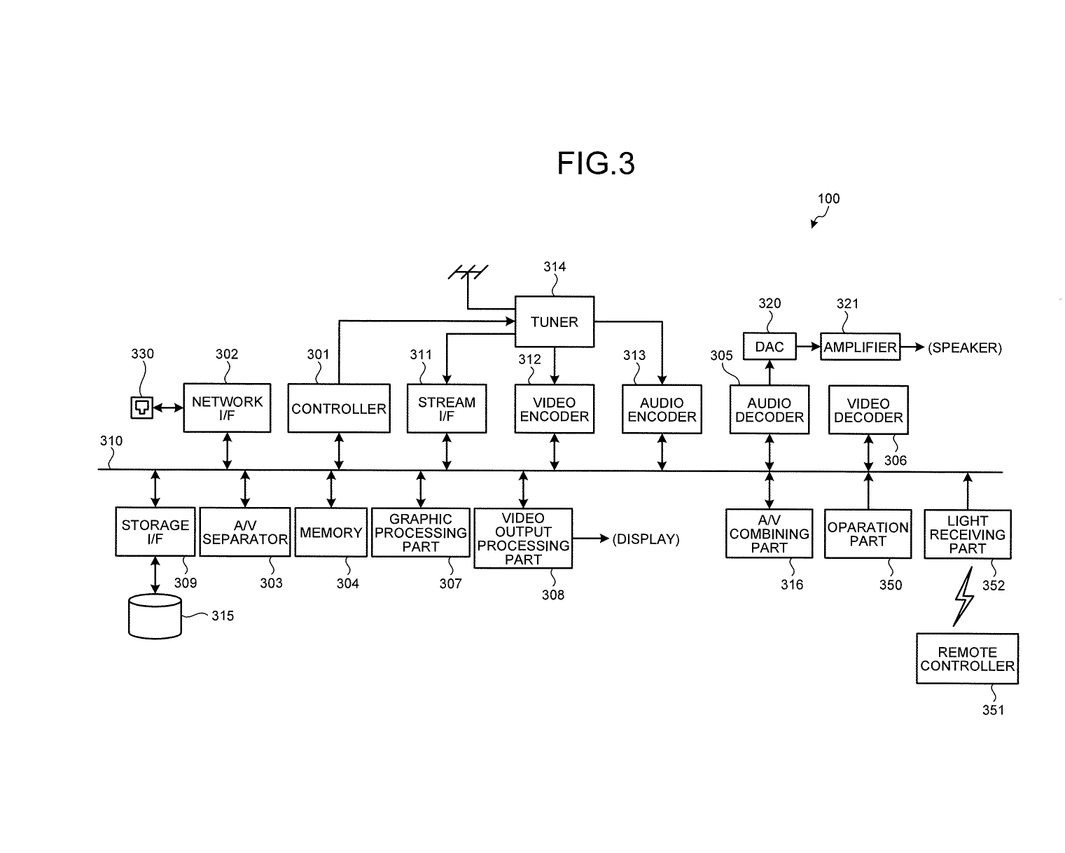

FIG. 3 is a block diagram illustrating a hardware configuration of the recorder.

The recorder 11 comprises, as illustrated in FIG. 3, a controller 301, a network I/F 302, an A/V separator 303, a memory 304, an audio decoder 305, a video decoder 306, a graphic processing part 307, a video output processing part 308, a storage I/F 309, a bus 310, a stream I/F 311, a video encoder 312, an audio encoder 313, a tuner 314, a hard disk drive (HDD) 315, an A/V combining part 316, a DAC(D/A converter) 320, an amplifier 321, a terminal 330, an operation part 350, a remote controller 351, and a light receiving part 352.

The tuner 314 receives analog video signals, which are encoded by the video encoder 312. Furthermore, the tuner 314 receives analog audio signals, which are encoded by the audio encoder 313. The A/V combining part 316 combines the encoded video signals and audio signals, and generates a stream of combined signals. On the other hand, the tuner 314 receives digital video signals, which are input from the stream I/F 311 as a MPEG-2-TS (Transport Stream)-format stream, for example. The stream is recorded in the HDD 315 via the storage I/F 309. Furthermore, the HDD 315 stores therein the content information storage module 101 and the content data storage module 102 that are illustrated in FIG. 1.

The terminal 330 is an Ethernet (registered trademark) terminal or the like used for connecting with a network NT. The information input from the other device having a content transmitting function in the network NT is received by the tablet terminal device 13 through the terminal 330 and the network I/F 302.

The stream recorded in the HDD 315 or the content data input from the other device having the content transmitting function via the terminal 330 and the network I/F 302 and temporarily held in the memory 304 is separated into video data and audio data in the A/V separator 303 under the control of the controller 301. The separated video data is decoded by the video decoder 306. The decoded video data is output from the video output processing part 308 as a video signal, and displayed on an outside display screen (not illustrated in the drawings). Furthermore, the audio data separated in the A/V separator 303 is decoded by the audio decoder 305, and can be output from an outside speaker that is not illustrated in the drawings via the amplifier 321.

The controller 301 executes various programs stored in storage media such as the HDD 315 or a ROM (not illustrated in the drawings) to control the overall operation of the recorder 11. The controller 301 is constituted as a microprocessor unit and comprises a CPU that is not illustrated in the drawings, the ROM (not illustrated in the drawings) that stores therein various data, a RAM (not illustrated in the drawings) that stores therein various data and, at the same time, also functions as a work area, and an interface part (not illustrated in the drawings) that performs interface operations for connecting with the outside of the recorder 11.

To be more specific, the controller 301 operates in cooperation with the graphic processing part 307 to generate, for example, a GUI (Graphical User Interface) display window or the like, store the window in the memory 304 such as the RAM, and appropriately read out and display the window on the screen of an external display device that is not illustrated in the drawings. Furthermore, the controller 301 accepts the operation performed for the recorder 11 on the remote controller 351 or the like via the operation part 350 or the light receiving part 352. Furthermore, the controller 301 switches broadcasting signals (channels) received by the tuner 314 depending on the content of the operation accepted, or detects input operations performed on the GUI display window.

Next, the specific constitution of the tablet terminal device 13 is explained.

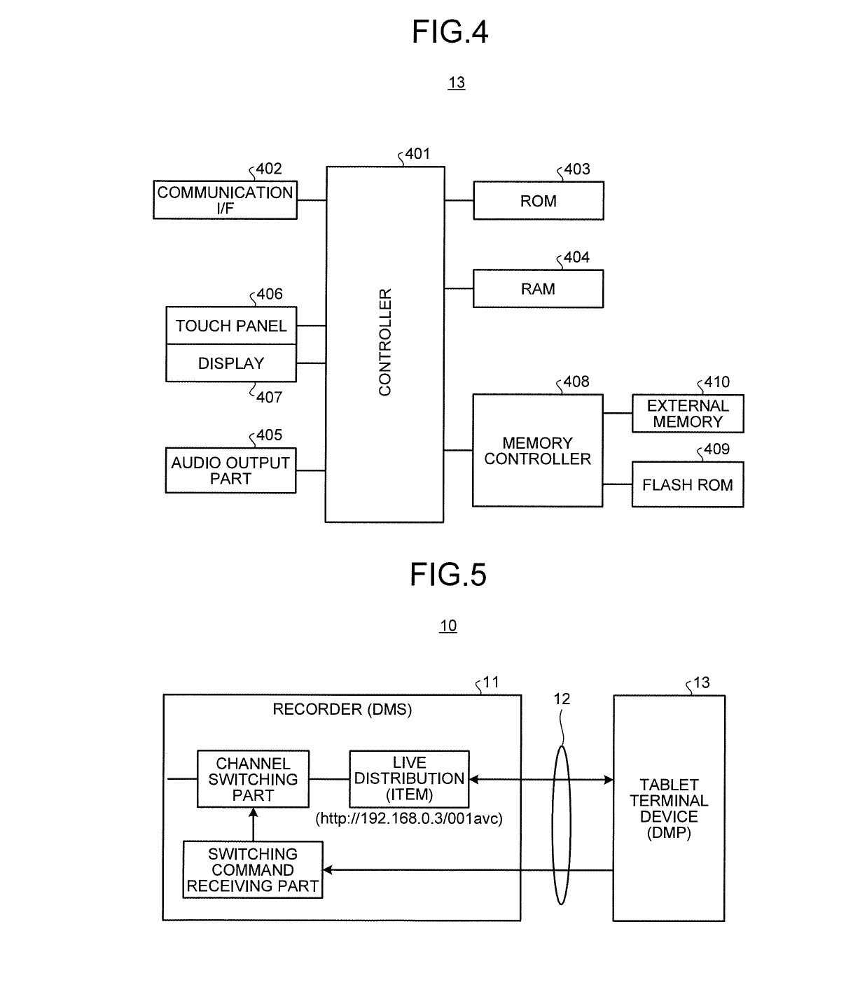

FIG. 4 is a block diagram illustrating a hardware configuration of the tablet terminal device.

The tablet terminal device 13 comprises, as illustrated in FIG. 4, a controller 401, a network I/F 402, a ROM 403, a RAM 404, an audio output part 405, a touch panel 406, a display 407, a memory controller 408, and a flash ROM 409.

Here, the touch panel 406 and the display 407 constitute a touch-screen display.

Furthermore, the memory controller 408 has a memory interface part (not illustrated in the drawings) to which an external memory 410 such as a memory card can be fixed.

The controller 401 executes various programs stored in the storage media such as the ROM 403 to control the overall operation of the tablet terminal device 13. The controller 301 is constituted as the microprocessor unit and comprises the CPU that is not illustrated in the drawings, the ROM (not illustrated in the drawings) that stores therein various data, the RAM (not illustrated in the drawings) that stores therein various data and, at the same time, also functions as a work area, and the interface part (not illustrated in the drawings) that performs the interface operations for connecting with the outside of the tablet terminal device 13.

To be more specific, the controller 401 generates a GUI (Graphical User Interface) display window or the like, store the window in the RAM or the like, and appropriately read out and display the window on the screen of the display 407. Furthermore, the controller 401 accepts the operation performed on the touch panel 406. Furthermore, the controller 401 performs various types of processing depending on the content of the operation accepted.

In the above-mentioned constitution, it is possible to perform both the operation such that the contents recorded by the recorder 11 are distributed and the operation such that a broadcast program being received by the tuner of the recorder 11 is distributed as contents (live distribution operation). In the following explanation, the live distribution operation is explained as an example.

FIG. 5 is a schematic explanatory view of the first embodiment.

The controller 301 that functions as the digital media server (DMS) in the recorder 11 arranges only one item for live distribution on the container tree of the CDS.

Therefore, it is not necessary to arrange a plurality of distributable items of the respective channels on the container tree.

Furthermore, the tablet terminal device 13 that functions as the digital media player transmits a HTTP GET command with one item for live distribution thus distributing the content data and starting live viewing.

However, only one item for live distribution is used and hence, it is impossible to change the channel as it stands. Accordingly, the present embodiment adopts the constitution such that a channel change command is used for designating the desired channel on the tablet terminal device 13 side. Due to such a constitution, the content being distributed is switched to content of the other channel while distributing by changing the data of the content to be distributed thus realizing the change of the channel. Therefore, it is unnecessary to interrupt the connection each time the channel is changed and follow a procedure of transmitting the HTTP GET command by using URL of the other channel and hence, it is possible to reduce time and efforts of user's operation and, at the same time, improve a speed of changing the channel.

Next, the manner of operation of the embodiment is explained.

Here, the explanation is made assuming that the tablet terminal device 13 stores, in advance, the list of broadcast channels (channel list) receivable (distributable) in the recorder 11 with the use of the method such that the list is obtained in advance from the recorder 11.

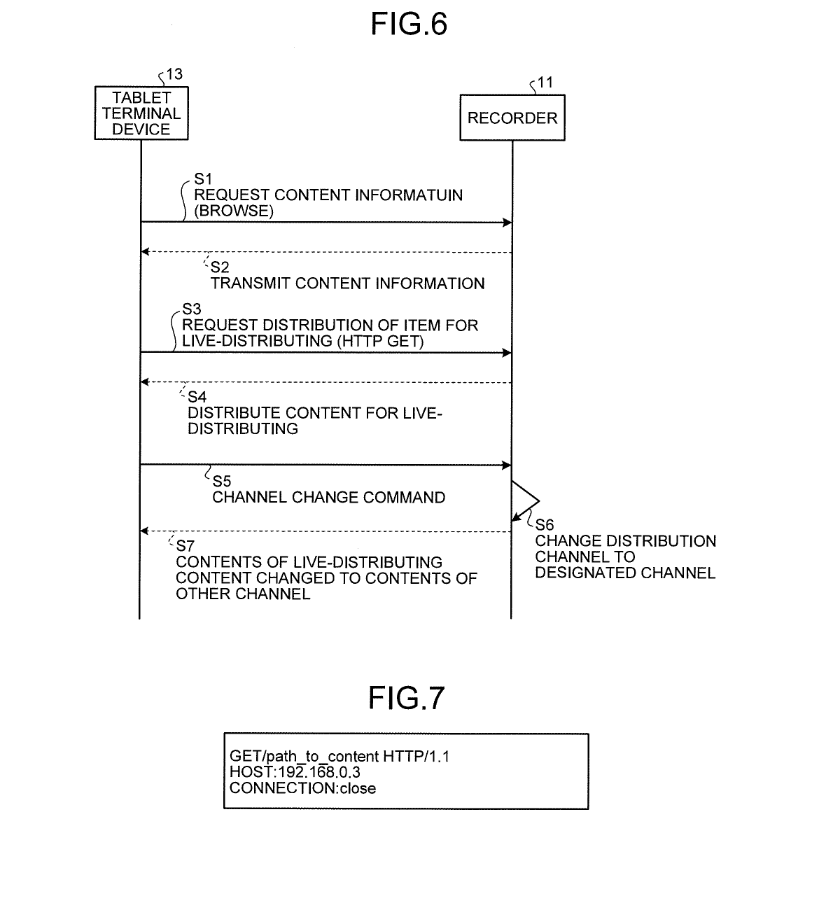

FIG. 6 is a processing timing chart of the content processing system in the embodiments.

The following explanation is made assuming that the URL of the recorder 11 is “192.168.0.3”, and URL in which the content is stored is, for example, “http://192.168.0.3/001.avc”.

The tablet terminal device 13 functions as the digital media player (DMP) and requests the content information (title information) from the recorder 11 that functions as the content server device (S1).

The recorder 11 receives the request for the content information and transmits the content information as a response to the request for the content information (S2).

Here, the content information is metadata of the item for distributing the contents (for live distribution in the present embodiment) and includes the URL in which the content is stored in addition to a content name and attribution information of the content.

In this case, it is possible to constitute one content so that the content includes a plurality of URLs (acquisition destinations) corresponding to various resolutions, bit rates, or the like and allow users to select a desired URL.

Next, the tablet terminal device 13 executes the HTTP GET command so as to request the distribution of the content data from the URL included in the content information acquired thereby (S3).

FIG. 7 is an explanatory view of one example of the HTTP GET command.

Here, the tablet terminal device 13 requests, as illustrated in FIG. 7, the distribution of the content data from the recorder 11 without designating the channel.

Thus, the recorder 11 distributes the content data corresponding to the channel that is currently received by the tuner 314 as a response to the HTTP GET command (S4).

As illustrated in FIG. 7, at this point of time, the tablet terminal device 13 does not designate the channel for live distribution and hence, live distribution of the channel currently selected in the tuner 314 of the recorder 11 is made. Since the distribution of the content data continues until the stop of the live distribution is commanded, the distribution of the content data continues even while executing subsequent S5 to S7. Accordingly, in the tablet terminal device 13, the live viewing is continuously enabled.

Here, the manner of operation performed when the channel to be viewed is changed is explained.

In the tablet terminal device 13, it is possible to transmit the channel change command while reproducing a live broadcast upon receipt of the distribution of the content data (S5).

The channel change command has, for example, the following format.

http://192.168.0.3/livech=G23760981

Here, “192.168.0.3” is an IP address of the recorder 11 as the digital media server. Furthermore, “livech” is a command name meaning the change of the live-distributing channel. Furthermore, “G23760981” is a channel code capable of uniquely showing the channel of a switching destination. The channel code is included in the channel information of the recorder 11 and is information to be acquired by the tablet terminal device 13 in advance and hence, it is possible to designate the cannel code from the tablet terminal device 13.

The channel change command is transmitted from the tablet terminal device 13 and received and accepted by the recorder 11. Thus, the recorder 11 changes the channel input in the content for live distribution to the channel designated by the channel change command accepted thereby (S6).

Accordingly, the content data for live distribution is switched to the contents of the other channel in the middle of the distributing, and the channel of the live broadcast reproduced in the tablet terminal device 13 is switched (S7).

As explained above, according to the first embodiment, it is unnecessary to arrange as many items as the distributable channels on the container tree.

Furthermore, it is unnecessary to interrupt the connection each time the channel is changed and follow a procedure of transmitting the HTTP GET command by using the URL of the other channel and hence, it is possible to reduce time and efforts of user's operation and, at the same time, improve the speed of changing the channel.

### [2] Second Embodiment

In the first embodiment described above, only one digital media player is used. In the second embodiment, a plurality of the digital media players are connected to only one digital media server. In this case, it is necessary to use a recorder as the digital media server and mount as many tuners as the digital media players performing live distribution. Here, it is possible to distribute, as long as the processing performance of the recorder allows, the recorded content to only one digital media player or a plurality of digital media players.

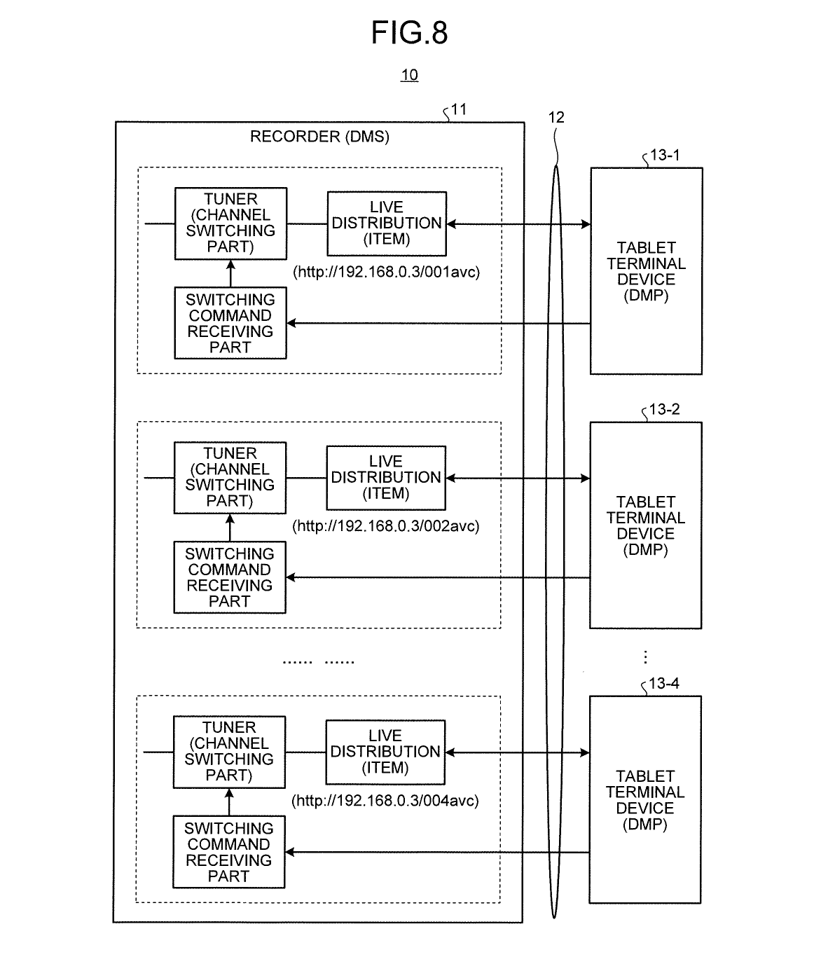

FIG. 8 is a schematic explanatory view of the second embodiment.

As many the controllers 301 of the recorder 11 functioning as the digital media server (DMS) as the digital media players (four (4) players in FIG. 8) performing live distribution of the item for live distribution are arranged on the container tree of the CDS.

Furthermore, with the use of the URL of one item for live distribution for each digital media player, the tablet terminal device 13 that functions as the digital media player transmits the HTTP GET command and hence, the content data is distributed and the live viewing is started.

However, in this case also, in the same manner as the case of the first embodiment, only one URL of the item for live distribution is used for each digital media player and hence, it is impossible for each digital media player to change the channel as it stands. Accordingly, in the same manner as the case of the first embodiment, the second embodiment also adopts the constitution such that a channel change command is used for designating the desired channel on the digital media player side.

Accordingly, in the second embodiment also, it is unnecessary to arrange as many items as a result of multiplying the number of the distributable channels by the number of the digital media players on the container tree.

Furthermore, it is unnecessary to interrupt the connection each time the channel is changed and follow a procedure of transmitting the HTTP GET command by using the URL of the other channel and hence, it is possible to reduce time and efforts of user's operation and, at the same time, improve the speed of changing the channel.

### [3] Modifications of Embodiments

The above explanation is made using the example of the case that the content data is live-distributed. However, the embodiment is not limited to the case that the content data is live-distributed, and can be applied to the use such that the distribution of the content being reproduced in the digital media player is switched to that of the other content data without transmitting the HTTP GET command again.

In the constitution of each embodiment described above, there exists the possibility that even when the channel change command is transmitted from the other digital media player (DMP) or the digital media controller (DMC) in which the live distributing is not performed, as long as the command format is appropriate, the contents of the content data distributed to the digital media player under live viewing are unexpectedly switched to the contents of the other channel. In order to prevent this phenomenon, it is also possible to perform the processing such that the IP address of the digital media player to which the content data is distributed by live distribution and the IP address of the digital media player that transmits the channel change command are checked in the digital media server. When the IP addresses are not identical with each other, the channel change command for live distribution is disabled.

The above explanation is made assuming that the digital media server (DMS) directly distributes the content data to a content reproducing device (external device) such as the digital media player (DMP) or the digital media renderer (DMR). However, it is also possible to constitute the digital media server (DMS) so that the digital media server (DMS) comprises the external device such as a data transfer device that transfers (distributes) the content data to the digital media player (DMP) or the digital media renderer (DMR) upon receipt of the distribution of the content data from the digital media server (DMS) in place of the digital media player (DMP) or the digital media renderer (DMR). That is, in this case, the destination of the content data distributed from the digital media server (DMS) is the external device having no reproducing function.

Furthermore, the explanation above is made assuming that the digital media server (DMS) has two functions; that is, the function of storing therein the content data and the function of distributing the content data. However, it is also possible to provide the functions as the digital media server (DMS) in such a constitution that the content data server that stores therein the content data is used in combination with a distribution server that acquires the content data from the content data server and distributes the content data to the content reproducing device.

Furthermore, a content processing program executed in the recorder 11 or the tablet terminal device 13 of the present embodiments may be provided in the form of an installable-format file or an executable-format file that is recorded in a recording medium such as a CD-ROM, a flexible disk (FD), a CD-R, or a DVD (Digital Versatile Disk).

Furthermore, the content processing program executed in the recorder 11 or the tablet terminal device 13 of the present embodiments may be stored in the computer connected to the network such as the Internet and provided by downloading via the network. Furthermore, the content processing program executed in the recorder 11 or the tablet terminal device 13 of the present embodiments may be provided or distributed via the network such as the Internet.

In addition, the content processing program of the present embodiments may be provided in the form of the ROM or the like into which the program is incorporated in advance.

The content processing program executed in the recorder 11 or the tablet terminal device 13 of the present embodiments is constituted of modules comprising each of the above-mentioned modules (content information storage module, content data storage module, digital media server functional module, or digital media player functional module). As actual hardware, the controller of each device reads out the content processing program from the memory and executes the program whereby each of the above-mentioned modules is loaded into a main memory, and the content information storage module, the content data storage module, the digital media server functional module, or the digital media player functional module is generated in the main memory.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A content processing system comprising:
a server device configured to distribute content data via a network; and
a content reproducing device configured to reproduce content based on the content data distributed via the network,
the server device comprising:
an acquisition destination allocating module configured to allocate one acquisition destination of the content data to be distributed to one content reproducing device; and
a distribution data switching module configured to switch the content data to be distributed based on a switching command received,
the content reproducing device comprising:
a content acquisition module configured to request the content data from the allocated acquisition destination of the content data to acquire the content data; and
a switching command transmitter configured to generate the switching command in switching the content data to be acquired from the acquisition destination of the content data to transmit the switching command to the server device.

2. The content processing system of claim 1, wherein
the server device comprises a switching command receiver configured to receive the switching command via the network and notify the distribution data switching module of the switching command.

3. A server device distributing content data to a content reproducing device via a network, the server device comprising:
an acquisition destination allocating module configured to allocate one acquisition destination of the content data to be distributed to one external device; and
a distribution data switching module configured to switch the content data to be distributed based on a switching command received from the external device via the network.

4. The server device of claim 3, further comprising:
a switching command receiver configured to receive the switching command via the network and notify the distribution data switching module of the switching command.

5. A content reproducing device acquiring content data from a server device via a network to reproduce the content data, the content reproducing device comprising:
a content acquisition module configured to request the content data from an acquisition destination of the content data to acquire the content data, the acquisition destination being allocated by the server device; and
a switching command transmitter configured to generate a switching command for requesting to switch the content data to be acquired from the acquisition destination of the content data to transmit the switching command to the server device.
